(19) United States
(12) Patent Application Publication
(10) Pub. No.: US 2010/0257883 A1
(43) Pub. Date: Oct. 14, 2010

(54) DEVICE FOR STORING ELECTRIC ENERGY

(76) Inventors: Herbert Damsohn, Aichwald (DE); Conrad Pfender, Besigheim (DE); Thomas Schiehlen, Altheim (DE); Martin Steinbach, Waiblingen (DE); Caroline Schmid, Stuttgart (DE)

Correspondence Address: Muncy, Geissler, Olds & Lowe, PLLC, 4000 Legato Road, Suite 310, FAIRFAX, VA, 22033, US

(21) Appl. No.: 12/762,126

(22) Filed: Apr. 16, 2010

Related U.S. Application Data
(63) Continuation of application No. PCT/EP2008/008340, filed on Oct. 2, 2008.

(30) Foreign Application Priority Data
Oct. 19, 2007 (DE) DE102007050400.6

(51) Int. Cl. F25D 31/00; H01M 10/50

(52) U.S. Cl. 62/259.2; 429/120

(57) ABSTRACT

A device for storing electrical energy, especially for a motor vehicle is provided. The device comprises a plurality of flat cells that are stacked one on the other with their flat sides substantially in parallel, the flat cells defining at least one first stack. A cooling element is arranged between adjacent flat cells of the at least one first stack. The cooling element has at least one opening into which a heat transfer element is inserted.

This nonprovisional application is a continuation of International Application No. PCT/EP2008/008340, which was filed on Oct. 2, 2008, and which claims priority to German Patent Application No. DE 10 2007 050 400.6, which was filed in Germany on Oct. 19, 2007, and which are both herein incorporated by reference.

### BACKGROUND OF THE INVENTION

1. Field of the Invention

The invention relates to a device for storing electric energy.

2. Description of the Background Art

Electrochemical energy storage units with a high power density are known in particular from the construction of motor vehicles with an electric drive, for example, a hybrid drive. These are lithium ion batteries, among other things. In addition, it is generally known to blow air at high-performance batteries of this type, for example from an air-conditioned passenger area or directly from an air conditioning system, to thereby cool the batteries.

Furthermore, it is known to embody batteries of this type as a stack of flat cells, which are provided with passages between adjacent cells. These passages are provided with a fluid, for example, a coolant, so that each flat cell is cooled directly. However, with this arrangement there is a problem that it is difficult to distribute the fluid uniformly among the passages. Furthermore, a considerable amount of installation space is lost due to the passages for the cooling fluid.

Therefore a uniform cooling of the flat cells and a structure that requires less space are desirable.

U.S. Pat. No. 6,821,671 B2 describes a cooling arrangement for cooling prismatic batteries. Heat-conducting cooling plates are hereby inserted between the flat cells. At their side end, the plates have cooling fins to dissipate the heat to a fluid.

### SUMMARY OF THE INVENTION

It is therefore an object of the invention to provide a device for storing electric energy in which a simple and safe installation in conjunction with a good thermal contact between the flat cell and the cooling element and subsequently to a heat removing fluid is given.

Consequently, an indirect cooling method is proposed, in which one or more cooling elements are arranged between the plurality of flat cells in order to cool them.

In an embodiment, first a stacking of the individual flat cells is performed to form at least one first stack, wherein respectively one cooling element of a material that conducts heat well is arranged between adjacent flat cells of the first stack. The individual cooling elements are larger in terms of surface than the flat side of a flat cell, so that the cooling element has a region spaced laterally apart from the flat cell, which region is not covered by a flat cell. In this region the cooling elements have at least one opening, into which a heat-transferring element is inserted in order to dissipate the heat occurring in the flat cells to a fluid that flows in the heat transferring element. A particularly simple and compact arrangement of the flat cells and connection to a heat sink is achieved through this embodiment.

In an alternative embodiment, a first and a second stack are formed by the flat cells. The same cooling element is hereby arranged between adjacent flat cells of the first as well as of the second stack. The individual cooling elements are larger in surface than two flat sides of a flat cell, so that a gap is formed between the first stack and the second stack. In this region, which corresponds approximately to the center of the cooling element, the cooling elements have at least one opening into which a heat transferring element is inserted. In the case of flat cells with increased power density, the cooling element can have further openings for heat transferring elements at the side edges, in order to render possible a higher heat dissipation to a cooling fluid that flows in the heat transferring elements.

Depending on the application, it can also be advantageous for several stacks to be formed by the flat cells. In this embodiment the same cooling element can be arranged between adjacent flat cells of these several stacks.

In another embodiment, respectively four flat cells, two flat cells from one stack, are connected, in particular adhered, to a cooling element. Thus one cooling element is arranged after every other flat cell seen in the stack direction.

Depending on the requirement for the cooling capacity, in an alternative embodiment a cooling element can be arranged after each after every third or fourth flat cell seen in the stack direction. In a generally advantageous manner the cooling element is composed of a metal, in particular from the group of aluminum, copper or aluminum with roller-applied copper and is preferably embodied as an inexpensive sheet-metal blank. The cooling plates preferably have a rectangular shape and can additionally be offset on at least one side in order to form a kind of receptacle for the flat cells. Alternatively, it is also possible for two cooling plates that are offset at the respective ends to form a cassette in which the flat cell is inserted. Thus two cooling plates are arranged between adjacent flat cells seen in the stack direction.

The thickness of the cooling element can be 0.2 to 2 mm, however, with increased cooling capacity it can be greater than 2 mm.

The heat transferring element can be embodied as a bifurcated pipe. In this case at least two, but preferably four, six or also more openings are provided in the metal sheet into which the bifurcated pipes are inserted. Alternatively, individual pipes instead of the bifurcated pipes can also be inserted into the openings, wherein the pipes, similar to an evaporator, at their respective ends are connected in a communicating manner with a collector, through which the fluid is distributed to the individual pipes.

The bifurcated pipes or pipes are connected to the cooling sheets by expansion at least in a positive or non-positive manner. Additionally, in an alternative embodiment the openings can be provided with a passage in order to facilitate the insertion of the bifurcated pipes and in order to represent a large enough contact surface between the pipe wall and the cooling sheet. The diameter of the bifurcated pipes is preferably between 4 and 10 mm. The passages are hereby preferably shaped on the cooling sheets, alternatively soldered. The mechanical bond and the bracing of the cell bond are also represented through the pipes.

A fluid flows into the bifurcated pipes, in particular a refrigerant or a coolant, for example, a mixture of water and glysantin.

In an embodiment, the bifurcated pipes can be connected in a communicating manner to a refrigerant circuit of a motor vehicle air-conditioning system. Alternatively, however, they can also be part of an independent circuit that is preferably thermally coupled to the refrigerant circuit of a motor vehicle air-conditioning system.

Further, a compressible material, such as a non-woven, is arranged at least after every or every other flat cell of a stack. The non-woven is inserted between the flat cells and is used for tolerance compensation.

In an alternative embodiment, the individual stacks in addition can be braced by metal strips and arranged in a housing, for example, made of plastic.

Of course the features cited above as well as those yet to be explained below can be used not only in the combination given in each case, but also in other combinations or alone, without leaving the scope of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a device for storing electric energy according to the present invention;

FIGS. 2-4 illustrate various embodiments for a cooling element according to the invention with openings;

FIG. 5 is a cooling element with a passage for a heat transferring element; and

FIGS. 6-8 illustrate a diagrammatic front view with two cell stacks with cooling elements.

### DETAILED DESCRIPTION

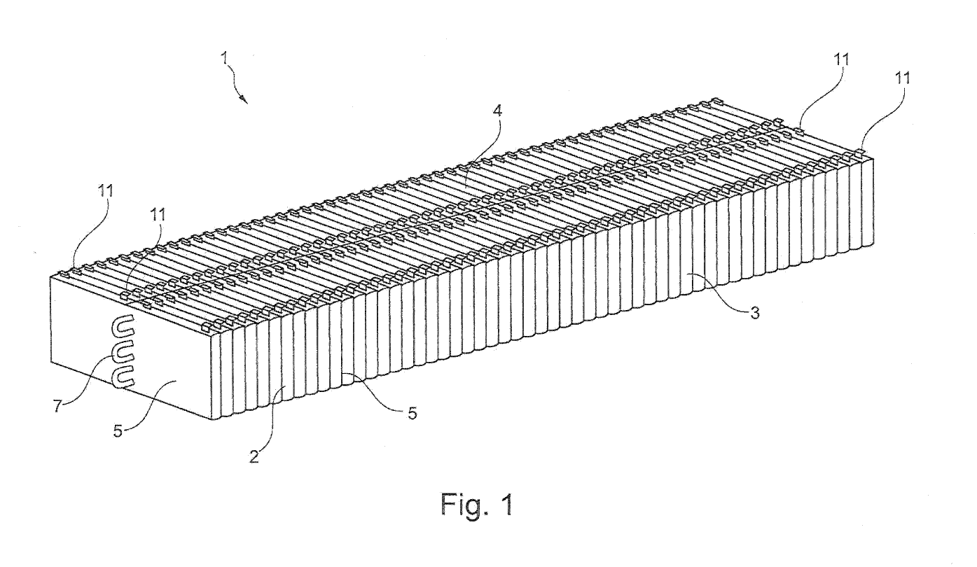

FIG. 1 shows a device for storing electric energy 1 according to the present invention. An energy storage unit of this type is composed of several flat cells 2, for example, lithium ion flat cells, which are arranged with their flat sides 10 in the manner of a stack one on top of the other and form a cell stack. According to the invention, the flat side of the flat cell 2 means the side with the larger surface, which indirectly or directly adjoins a flat side of an adjacent flat cell 2. A first cell stack 3 and a second 4 cell stack are formed by the flat cells and the cooling sheets 5 arranged between adjacent flat cells, wherein each stack has the same number of flat cells. In addition, the individual flat cells are sorted by thickness before being stacked in order to ensure a corresponding tolerance compensation.

The same cooling plate 5 hereby serves to dissipate heat from flat cells of the first stack 3 as well as from flat cells of the second stack 4. In addition, a further cooling plate 5 is arranged on at least one end of the first and second stack. Respectively four flat cells, two each on one side of the cooling plate, are attached, preferably adhered, to a cooling plate 5, so that a cooling plate follows after every other flat cell in the stack direction. When the waste heat produced by the flat cells becomes too great, alternatively a cooling plate can be arranged between each flat cell.

The cooling plates are of a material that conducts heat well, such as aluminum, copper, an aluminum-containing alloy or aluminum with roller-applied copper. The sheets are embodied in a rectangular manner and preferably have a thickness between 0.2 and 2 mm.

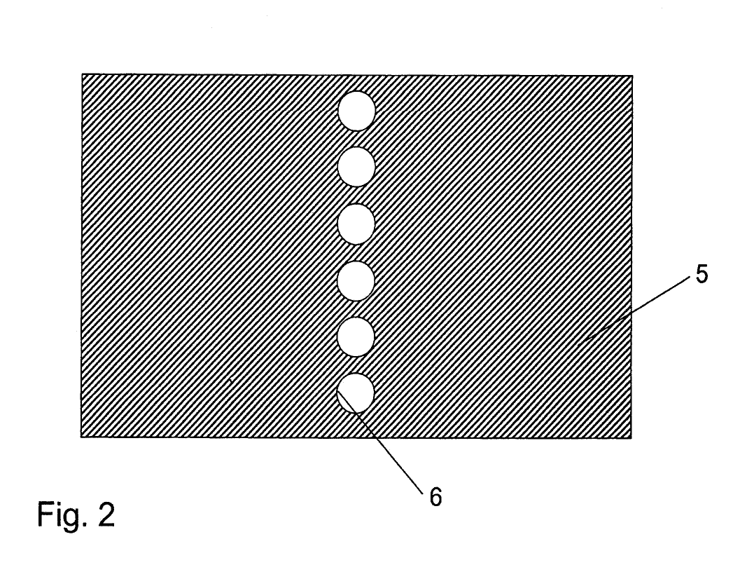

The cooling plates have respectively six openings (see FIG. 2) between the first and second stack, into which openings three bifurcated pipes are inserted, which extend through the entire cell composite, comprising the first and the second stack. The bifurcated pipes are likewise composed of a material that conducts heat well and are connected to the cooling sheets in a positive and non-positive manner, which is achieved by a mechanical or hydraulic expansion.

In a manner not shown, the open ends of the bifurcated pipes 7 are connected in a communicating manner, for example, welded and subsequently connected to a refrigerant circuit or a coolant circuit. A fluid, for example, a refrigerant or a coolant, for example a water/glysantin mixture, flows in the pipes 7.

On their narrow sides the flat cells respectively have two arresters (electric cell connections) 11, which in a manner not shown are electrically contacted in order to guarantee a parallel or in particular a serial interconnection of the individual flat cells.

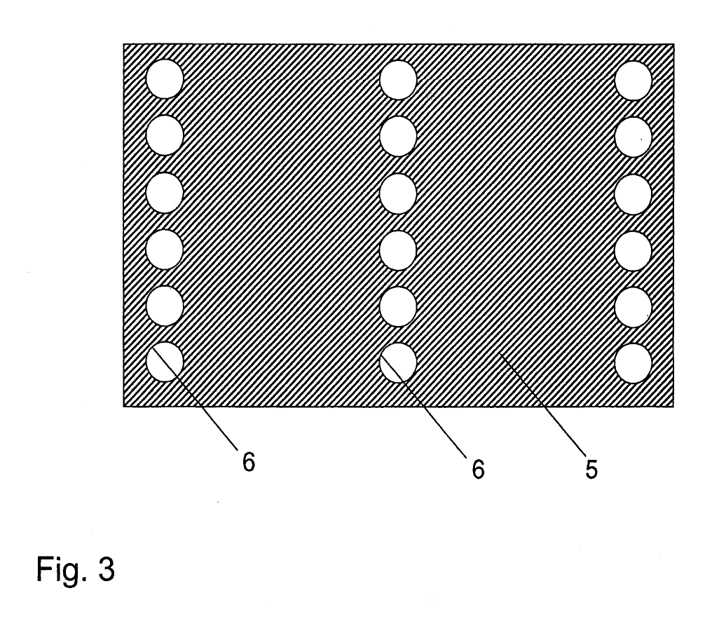

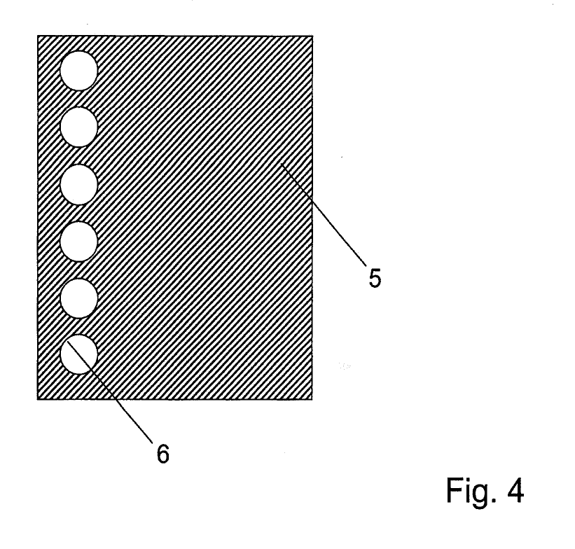

FIGS. 3 and FIG. 4 show two further exemplary embodiments for a cooling plate 5. In FIG. 3, in addition to the six openings in the central region of the cooling plate, respectively six further openings are embodied on the lateral edges, wherein the number of openings should be considered to be non-restricting. In the exemplary embodiment shown in FIG. 4, the cooling plate 5 has openings only on one lateral edge. A cooling plate 5 of this type is preferably suitable for forming a stack. In this case, the surface of a cooling plate is greater than the surface of the flat side of a flat cell. Thus a region is produced in which the openings 6 are arranged.

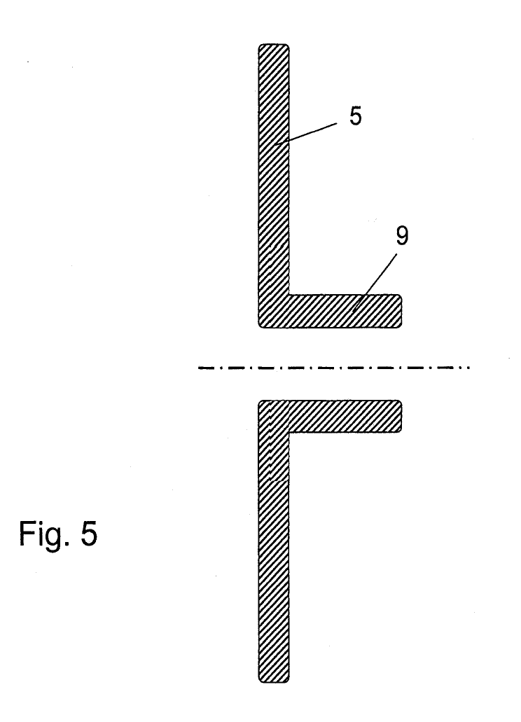

FIG. 5 shows a further alternative embodiment of a cooling plate according to the invention. In this embodiment, the cooling plates 5 are provided with passages 9, which are preferably shaped on the cooling plate. Through an embodiment of this type, the insertion of the bifurcated pipes is considerably facilitated and the contact surface between the tube and the cooling plate is considerably enlarged.

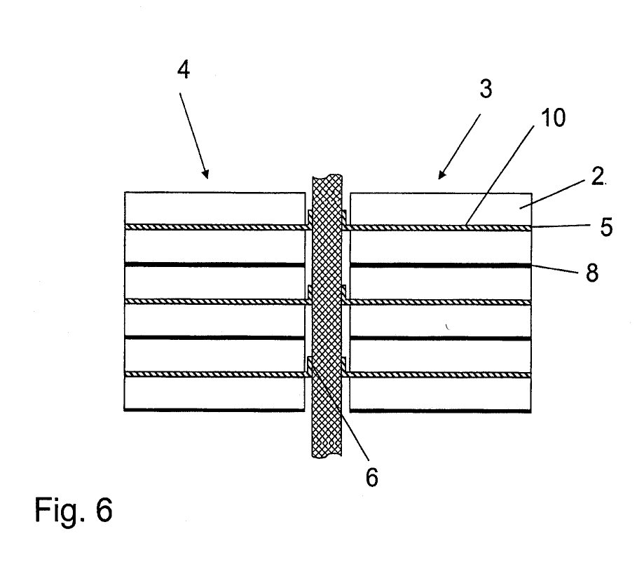

In the exemplary embodiments shown in FIG. 6 through FIG. 9, a compressible material 8, for example, a non-woven, a woven fabric or a felt mat is arranged between the flat cells 2 of the first stack 3 and the second stack 4. The compressible material is used for tolerance compensation and the mechanical bracing for thermal contacting and preferably has a thickness of 0.5 to 2 mm. Depending on the requirements, the compressible material can be only inserted between the flat cells or adhered thereto in addition.

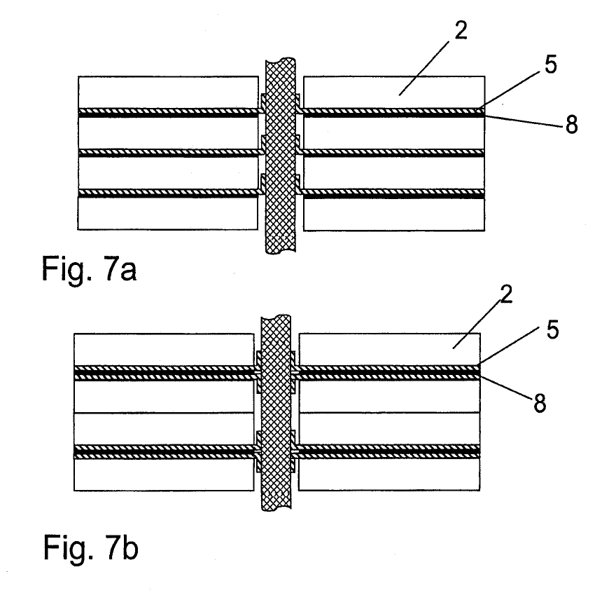

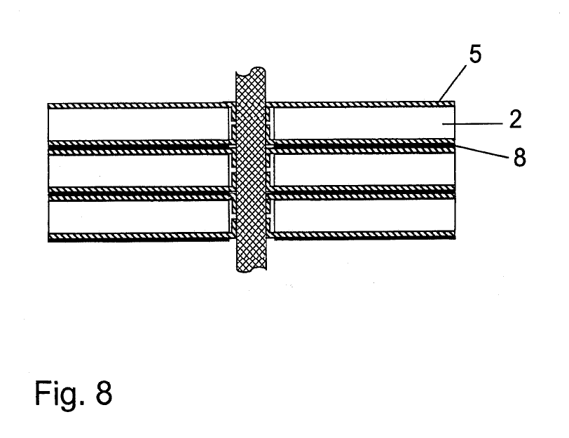

In FIG. 6 and FIG. 7b a non-woven is arranged after every other flat cell hereby, in FIG. 7a and FIG. 8a a non-woven is arranged after every flat cell.

The exemplary embodiments shown in FIG. 6 through FIG. 8 are, of course, also conceivable without compressible material 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for storing electric energy for a motor vehicle, the device comprising:
a plurality of flat cells arranged with their flat sides arranged essentially parallel to one another in a stack such that the flat cells are positioned one on top of the other, wherein at least one first stack is formed by the flat cells; and
a cooling element arranged between adjacent flat cells of the at least one first stack, the cooling element having at least one opening into which a heat transferring element is inserted.

2. The device according to claim 1, wherein the cooling element has a larger surface than the flat side of the flat cell.

3. The device according to claim 1, wherein the at least one opening of the cooling element is arranged spaced apart laterally from the flat cell.

4. The device according to claim 1, wherein a second stack is formed by the flat cells.

5. The device according to claim 4, wherein a same cooling element is arranged between adjacent flat cells of the first stack as well as also of the second stack.

6. The device according to claim 4, wherein the at least one opening is arranged between the first stack and the second stack.

7. The device according to claim 1, wherein several stacks are formed by the flat cells, wherein the same cooling element is arranged between adjacent flat cells of these several stacks.

8. The device according to claim 1, wherein the cooling element is a cooling plate formed of aluminum, copper, an aluminum-containing alloy or aluminum with roller-applied copper.

9. The device according to claim 1, wherein one or two cooling elements are arranged on each flat cell.

10. The device according to claim 1, wherein the cooling element is connectable to one or two adjacent flat cells in a positive and/or adhesive manner.

11. The device according to claim 1, wherein a compressible material or a non-woven is arranged between adjacent flat cells of a stack after every or every other flat cell.

12. The device according to claim 1, wherein the heat transferring element is a bifurcated pipe.

13. The device according to claim 1, wherein the at least one opening of the cooling element has a passage into which the heat transferring element is insertable.

14. The device according to claim 13, wherein the passage is shaped on the cooling element.

15. The device according to claim 1, wherein the first stack and the second stack or the several stacks have the same number of flat cells.

16. The device according to claim 1, wherein the flat cells are lithium ion flat cells or NiMH flat cells.

17. The device according to claim 1, wherein the heat transferring element is connectable to a refrigerant circuit of a motor vehicle air-conditioning system.

18. The device according to claim 1, wherein the heat transferring element is part of a circuit that is configured to be thermally coupled to a refrigerant circuit.

19. The device according to claim 1, wherein the heat transferring element is part of an independent refrigerant circuit.

20. The device according to claim 18, wherein the coolant is water or a mixture of water and glysantin.
